(19) United States
(12) Patent Application Publication
(10) Pub. No.: US 2007/0072104 A1
(43) Pub. Date: Mar. 29, 2007

(54) Toner and image forming method

(76) Inventors: Naruo Yabe, Osaka-shi (JP); Kouzou Teramoto, Osaka-shi (JP); Kousuke Sato, Osaka-shi (JP); Tomohiko Kubo, Osaka-shi (JP)

Correspondence Address: CLARK & BRODY, 1090 VERMONT AVENUE, NW, SUITE 250, WASHINGTON, DC, 20005, US

(21) Appl. No.: 11/528,310

(22) Filed: Sep. 28, 2006

(30) Foreign Application Priority Data
Sep. 29, 2005 (JP) 2005-285669

(51) Int. Cl. G03G 9/08

(52) U.S. Cl. 430/108.6; 430/97

(57) ABSTRACT

When a titanium oxide surface-treated with a titanate-based coupling agent is used as an external additive on the surface of toner particles, titanium oxides are likely to be aggregated with each other and aggregated titanium oxide particles are likely to fall off from the surface of the toner. As a result, since toner particles do not support a required amount of titanium oxide particles, poor charging of the toner may occur and fog increases. Therefore, when a toner for electrostatic latent image development comprises color particles containing at least a binder resin and a colorant, and titanium oxide, as an external additive, formed on the surface of the color particles, the titanium oxide being surface-treated with a titanate-based coupling agent containing 30% or less of a solvent soluble component, aggregation of titanium oxides can be reduced and stable charging of the toner can be achieved, and thus the resulting image is stable for a long period.

Priority is claimed on Japanese Patent Application No. 2005-285669 filed on Sep. 29, 2005, the disclosure of which is incorporated by reference in its entirety.

### BACKGROUND OF THE INVENTION

1. Field of the Invention

The present invention relates to a toner for electrostatic latent image development, which contains external additive particles, and an image forming method using the same. More particularly, the present invention relates to a toner for electrostatic latent image development, which is obtained by adding specific external additive particles having excellent balance between charging characteristics and fluidity to toner particles as color particles, and an image forming method using the same.

2. Description of Related Art

A toner used when an electrostatic latent image is converted into a visible image in electrophotography is generally produced by the following procedure. That is, a thermoplastic resin (binder resin), waxes, a charge control agent, a magnetic powder and other additives are premixed and the resulting premix is subjected to the respective production steps such as melt-kneading step, pulverizing step and classifying step to give a toner having a desired particle size. After accumulating a fixed amount of charges on the resulting toner by triboelectrification, an electrostatic latent image on a photoconductor is developed thereby to visualize a desired image. It is necessary to enable charges to be accumulated on the toner by triboelectrification to be positive or negative according to the kind of the photoconductor on which the electrostatic latent image is formed and a latent image forming method (reversal development, normal development). Also it is necessary that the charge amount of the toner due to triboelectrification is controlled to a proper amount required to convert an electrostatic latent image into a visible image more accurately. Recently, as a photoconductor for formation of an electrostatic latent image, an amorphous silicone photoconductor (hereinafter referred to as a-Si photoconductor) has sometimes been used, together with an organic photoconductor (hereinafter referred to as OPC), because it does not cause pollution and has high sensitivity and also has high Vickers hardness within a range from 1,500 to 2,000. Since this a-Si photoconductor has high hardness and is excellent in durability, it is required to use a toner which is excellent in chargeability and durability and is also capable of polishing foreign matters adhered on the surface of the photoconductor and, if necessary, the surface of the photoconductor itself so as to develop an electrostatic latent image formed on the a-Si photoconductor.

Therefore, not only a charge control agent and a conductive material are added in a binder resin, but also polarity and charge amount of electric charges are controlled and also durability and polishing properties are controlled by externally adding inorganic oxides (fine powders) such as silica, aluminum oxide, titanium oxide and zinc oxide to the toner (toner particles).

However, these inorganic oxides have very high hydrophilicity because of a hydroxyl group existing on the surface. As a result, when added in the toner, humidity exerts an adverse influence on fluidity and charge buildup characteristics of the toner, thereby to cause deterioration of printing durability and image density.

To prevent an adverse influence of environmental conditions such as humidity, the inorganic oxide is treated with a hydrophobizing agent and a polar group is introduced. For example, there is proposed a technique in which a titanium oxide treated with a silane coupling agent such as aminosilane compound is used so as to introduce a polar group {see, for example, Japanese Unexamined Patent Publication (Kokai) No. 52-135739 (hereinafter referred to as Patent Document 1) and Japanese Unexamined Patent Publication (Kokai) No. 10-3177 (hereinafter referred to as Patent Document 2)}.

Also there is proposed an electrostatic latent image developing agent in which a ratio of the particle size of toner particles to the particle size of fine abrasive particles is controlled by fixing fine abrasive particles made of alumina and zirconia to the surface of toner particles {see, for example, Japanese Unexamined Patent Publication (Kokai) No. 5-181306 (hereinafter referred to as Patent Document 3)}.

The method disclosed in this patent document exerts an excellent effect of polishing the surface of a photoconductor and does not require a large system such as washing brush to be assembled, and also can reduce the size of an apparatus and exerts a good effect on image deletion, image density and fog.

However, these prior arts had the following problems.

(1) In the prior arts disclosed in Patent Document 1 and Patent Document 2, polishing ability to the surface of the photoconductor is insufficient and problems such as drum filming may occur.

(2) In the prior art disclosed in Patent Document 3, although proper polishing ability to the surface of the photoconductor can be exerted, charging characteristics are unstable in both environmental conditions, for example, high-temperature and high-humidity conditions and low-temperature and low-humidity conditions.

To solve these problems, there is proposed that the surface of a titanium oxide as an external additive having a polishing effect is surface-treated with a titanate-based coupling agent (see, for example, Japanese Unexamined Patent Publication (Kokai) No. 2001-318488).

However, the present inventors have studied more intensively about those obtained by surface treatment of the surface of a titanium oxide using a titanate-based coupling agent and found the followings. That is, when the unreacted coupling agent is remained on the surface of the titanium oxide treated with the titanate-based coupling agent, adhesion to the surface of the titanium oxide increases according to the residual amount and thus the titanate-based coupling agent is likely to adhere to the matter to be contacted such as drum, and also titanium oxides are likely to be adhered with each other and are not uniformly dispersed, sometimes. When the titanium oxides are aggregated and externally added to the surface of the toner, the particle size (secondary particle size) of the titanium oxide aggregate increases and the aggregate is likely to fall off from the surface of the toner, and thus the polishing effect of the photoconductor decreases. Consequently, poor charging of the toner may occur and problems such as severe fog arise.

### SUMMARY OF THE INVENTION

The resent invention provides a toner which does not cause problems involved in the surface of the photoconductor, for example, “photoconductor adhesion” and “photoconductor contamination”, and is also capable of forming a stable image for a long period, and an image forming method using the same.

The toner of the present invention is a toner for electrostatic latent image development, comprising color particles containing at least a binder resin and a colorant, and an external additive added externally on the surface of the color particles, wherein a titanium oxide is used as the external additive and the titanium oxide is surface-treated with a titanate-based coupling agent, and also the content of a solvent soluble component of the titanate-based coupling agent is 30% or less. The solvent is preferably n-hexane.

The image forming method of the present invention is an image forming method, which comprises the step of developing an electrostatic latent image on the surface of a photoconductor using the above toner for electrostatic latent image development. The photoconductor is preferably a-Si photoconductor.

By adjusting the content of the solvent soluble component of titanate-based coupling agent of the titanium oxide treated with the titanate-based coupling agent to 30% or less, surface adhesion of the titanium oxide particles decreases and adhesion to the photoconductor can be suppressed, and also aggregation between titanium oxides decreases and falling of the titanium oxide from the toner decreases, and thus problems involved in the surface of the photoconductor (“photoconductor adhesion” and “photoconductor contamination”) do not arise and a stable image can be supplied for a long period.

### DESCRIPTION OF PREFERRED EMBODIMENTS

The embodiment of the present invention is characterized by using, as an external additive, a titanium oxide which is obtained by treating the surface of toner particles as color particles with a titanate-based coupling agent and adjusting the content of a solvent soluble component of the titanate-based coupling agent to 30% or less. The toner particles and the external additive will now be described, separately.

1. Toner Particles

(1) Binder Resin

(a) Kind

The kind of the binder resin used in toner particles in the present invention is not specifically limited and, for example, it is preferred to use thermoplastic resin such as styrene-based resin, acrylic resin, styrene-acrylic copolymer, polyethylene-based resin, polypropylene-based resin, vinyl chloride-based resin, polyester-based resin, polyamide-based resin, polyurethane-based resin, polyvinyl alcohol-based resin, vinylether-based resin, N-vinyl-based resin or styrene-butadiene resin.

More specifically, the polystyrene-based resin may be a homopolymer of styrene, or a copolymer with the other copolymerizable monomer capable of copolymerizable with styrene. Examples of the copolymerizable monomer include p-chlorostyrene; vinylnaphthalene; ethylenically saturated monoolefins such as ethylene, propylene, butylenes and isobutylene; vinyl halide such as vinyl chloride, vinyl bromide or vinyl fluoride; vinylesters such as vinyl acetate, vinyl propionate, vinyl benzoate and vinyl butyrate; (meth)acrylate ester such as methyl acrylate, ethyl acrylate, n-butyl acrylate, isobutyl acrylate, dodecyl acrylate, n-octyl acrylate, 2-chloroethyl acrylate, phenyl acrylate, α-chloromethyl acrylate, methyl methacrylate, ethyl methacrylate or butyl methacrylate; other acrylic acid derivative such as acrylonitrile, methacrylonitrile or acrylamide; vinylethers such as vinyl methyl ether and vinyl isobutyl ether; vinyl ketones such as vinyl methyl ketone, vinyl ethyl ketone and methyl isopropenyl ketone; and N-vinyl compound such as N-vinylpyrrole, N-vinylcarbazole, N-vinylindol or N-vinylpyrrolidene. These copolymerizable monomers can be used alone and are copolymerizable with a styrene monomer, or can be used in combination and are copolymerizable with a styrene monomer.

The polyester-based resin may be preferably used as long as it can be obtained by condensation polymerization or co-condensation polymerization of an alcohol component and a carboxylic acid component.

Examples of the alcohol component include diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol and polytetramethylene glycol; bisphenols such as bisphenol A, hydrogenated bisphenol A, polyoxyethylenated bisphenol A and polyoxypropylenated bisphenol A; sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane and 1,3,5,-trihydroxymethylbenzene.

As the carboxylic acid component, dihydric or trihydric carboxylic acid, or an acid anhydride in these carboxylic acids, or a lower alkyl ester in these carboxylic acids are used. More specific examples thereof include dihydric carboxylic acid such as maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, or n-butylsuccinic acid, n-butenylsuccinic acid, isobutylsuccinic acid, isobutenylsuccinic acid, n-octylsuccinic acid, n-octenylsuccinic acid, n-dodecylsuccinic acid, n-dodecenylsuccinic acid, isododecylsuccinic acid or isododecenylsuccinic acid; and tri- or polyhydric carboxylic acid such as 1,2,4-benzenetricarboxylic acid (trimellitic acid), 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid or enpole trimer acid.

(b) Molecular weight distribution

The binder resin preferably has at least two molecular weight distribution peaks (low molecular weight peak and high molecular weight peak) in a weight average molecular weight measured by gel permeation chromatography (GPC). Specifically, the binder resin is preferably a binder resin in which a low molecular weight peak is preferably within a range from 3,000 to 20,000 and a high molecular weight peak is within a range from 3×10⁵ to 15×10⁵. This reason is as follows. That is, when the low molecular weight peak is within the above range, fixation properties of the toner for electrostatic latent image development are improved. On the other hand, when the low molecular weight peak is less than 3,000, offset is likely to occur during fixation and storage stability at an operating environment temperature (5 to 50° C.) of the toner for electrostatic latent image development decreases and caking may occur. When the high molecular weight peak is within the above range, offset properties of the toner for electrostatic latent image development are improved. On the other hand, when the high molecular weight peak is more than 20,000, compatibility between the binder resin and the charge control agent deteriorates and uniform dispersion can not be obtained. Therefore, fog, photoconductor contamination and poor fixation are likely to occur.

In the binder resin, a ratio of a weight average molecular weight (Mw) to a number average molecular weight (Mn), (Mw/Mn), is preferably 10 or more. This reason is as follows. That is, when the ratio Mw/Mn is less than 10, fixation properties and offset properties of the toner for electrostatic latent image development may deteriorate and both characteristics may not be satisfied.

(c) Crosslinked Structure

In view of good fixation properties, the binder resin is preferably a thermoplastic resin. When the amount of the crosslinked component (gel amount) measured by a Soxhlet extractor is preferably 10% by weight or less, and more preferably from 0.1 to 10% by weight, a curable resin may be used. As described above, by partially introducing a crosslinked structure, storage stability, shape retention and durability of toner particles can be more improved without deteriorating fixation properties. Therefore, it is not necessary to use 100% by weight of a thermoplastic resin as a binder resin of toner particles, and it is preferred that a crosslinking agent is added and a thermosetting resin is partially used.

Examples of the thermosetting resin include epoxy-based resin and cyanate-based resin and, more specifically, bisphenol A type epoxy resin, hydrogenated bisphenol A type epoxy resin, novolak type epoxy resin, polyalkylene ether type epoxy resin, cyclic aliphatic type epoxy resin and cyanate resin are used alone or in combination.

(d) Functional Group

To improve dispersibility of magnetic particles, it is preferred to have a functional group in the binder resin. Examples of the functional group include at least one selected from hydroxyl group, carboxyl group, amino group and glycidoxy (epoxy) group.

It can be confirmed by a fourier transform infrared spectrometer (FT-IR) apparatus whether or not the binder resin has a functional group, and the content of the functional group can be determined by a titration method.

(e) Glass Transition Point

A glass transition point of the binder resin is preferably adjusted within a range from 55 to 70° C.

This reason is considered as follows. That is, when the glass transition point of the binder resin is lower than 55° C., the resulting toners for electrostatic latent image development are fused with each other and storage stability may deteriorate.

On the other hand, when the glass transition point of the binder resin is higher than 70° C., toner particles may be insufficient in fixation properties. Therefore, the glass transition point of the binder resin is preferably adjusted within a range from 58 to 68° C., and more preferably from 60 to 66° C. The glass transition point of the binder resin can be determined from a turning point of specific heat using a differential scanning calorimeter (DSC). In accordance with ASTM D3418-82, using Q-1000 manufactured by TA Instruments, a DSC curve was measured at a temperature-rising rate of 10° C./min after taking the pre-history by raising/lowering the temperature once. The temperature at an intersection point of the DSC curve and a line connecting midpoints of a baseline before and after appearance of change in specific heat in the DSC curve on heating was taken as T_{g}.

(f) Softening Point

When the binder resin is crystalline, the softening point is preferably adjusted within a range from 110 to 150° C. This reason is as follows. That is, when the softening point of the binder resin is lower than 110° C., the resulting toners are fused with each other and storage stability may deteriorate. On the other hand, when the softening point of the binder resin is higher than 150° C., fixation properties of toner particles may drastically deteriorate.

Therefore, the softening point of the binder resin is preferably adjusted within a range from 115 to 145° C., and more preferably from 120 to 140° C.

The softening point of the binder resin can be measured by using a flow tester Model CFT-500, manufactured by Shimadzu Corporation. Specifically, it can be measured by the following procedure.

While heating 1 g of a sample at a temperature-rising rate of 6° C./min, a load of 1.96 MPa was applied to the sample by a plunger and the sample was pushed out from a nozzle measuring 1 mm in diameter and 1 mm in length. Whereby, a plunger fall out amount (flow value)-temperature curve of a flow tester was drawn and the temperature (temperature at which a half of the resin flowed out) corresponding to h/2, where h denotes a height of the S-shaped curve, is taken as a softening point.

(2) Waxes

In the toner of the present invention for electrostatic latent image development, waxes are preferably added because fixation properties and offset properties can be improved.

The kind of waxes to be added is not specifically limited and, for example, polyethylene wax, polypropylene wax, Teflon® wax, Fischer-Tropsch wax, paraffin wax, ester wax, montan wax and rice wax are preferably used. These waxes may be used in combination.

By adding these waxes, offset properties can be improved and image smearing can be prevented more efficiently. Fischer-Tropsch wax is a linear hydrocarbon compound containing less iso structure molecules and side chains produced by utilizing the Fischer-Tropsch reaction as the catalytic hydrogenation reaction of carbon monoxide.

Among Fischer-Tropsch waxes, those having a weight average molecular weight of 1,000 or more and an endothermic bottom peak as measured by DSC within a range from 100 to 120° C. are preferable. Examples of the Fischer-Tropsch wax include SASOL wax C1 (high molecular weight grade due to crystallization of H1, endothermic bottom peak: 106.5° C.), SASOL wax C105 (purified product due to componental distillation of C1, endothermic bottom peak: 102.1° C.) and SASOL wax SPRAY (fine particle product of C105, endothermic bottom peak: 102.1° C.) which are commercially available from SASOL Corporation.

The amount of waxes to be added is not also specifically limited. For example, if the entire amount of the toner for electrostatic latent image development is 100% by weight, the amount of waxes is preferably adjusted within a range from 1 to 5% by weight. This reason is as follows. That is, when the amount of waxes is less than 1% by weight, offset properties and image smearing can not be efficiently prevented.

On the other hand, when the amount of waxes is more than 5% by weight, toners for electrostatic latent image development are fused with each other and storage stability may deteriorate.

(3) Charge Control Agent

In the toner of the present invention for electrostatic latent image development, a charge control agent is preferably added because charge level and charge buildup characteristics (indicator which indicates charging at a fixed charge level within a short time) are remarkably improved and excellent characteristics such as durability and stability are obtained. The kind of the charge control agent is not specifically limited and examples thereof include the following positive charge type charge control agents which can be used in the a-Si photoconductor.

(a) Kind

Examples of the positive charge type charge control agent include charge control agents such as nigrosin, quaternary ammonium salt compound, and resin type one obtained by bonding a resin with an amine-based compound.

Specific examples thereof include azine compound such as pyridazine, pyrimidine, pyrazine, orthooxazine, methoxazine, paraoxazine, orthothiazine, meththiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline or quinoxaline; direct dye composed of an azine compound, such as azine fast red FC, azine fast red 12BK, azine violet BO, azine brown 3G, azine light brown GR, azine dark green BH/C, azine deep black EW or azine deep black 3RL; a nigrosin compound, such as nigrosin, nigrosin salt or nigrosin derivative; acid dye composed of a nigrosin compound, such as nigrosin BK, nigrosin NB or nigrosin Z; metal salt of naphthenic acid or higher fatty acid; alkoxylated amine, alkylamide; and quaternary ammonium salt such as benzylmethylhexyldecylammonium or decyltrimethylammonium chloride; and these charge control agents may be used alone or in combination.

A nigrosin compound is particularly suited for use as the charge control agent in the positive charge type toner for electrostatic latent image development because rapid charge buildup characteristics are obtained.

Also a resin or oligomer having a quaternary ammonium salt, a resin or oligomer having a carboxylate, and a resin or oligomer having a carboxyl group are exemplified.

More specific examples thereof include polystyrene-based resin having a quaternary ammonium salt, acrylic resin having a quaternary ammonium salt, styrene-acrylic resin having a quaternary ammonium salt, a polyester-based resin having a quaternary ammonium salt, polystyrene-based resin having a carboxylate, an acrylic resin having a carboxylate, styrene-acrylic resin having a carboxylate, polyester-based resin having a carboxylate, polystyrene-based resin having a carboxyl group, acrylic resin having a carboxyl group, styrene-acrylic resin having a carboxyl group and polyester-based resin having a carboxyl group, and these resins can be used alone or in combination. In particular, a styrene-acrylic resin (styrene-acrylic copolymer) having a quaternary ammonium salt, carboxylic acid salt or carboxyl group as a functional group is an optimum charge control agent because the charge amount can be easily adjusted within a desired range.

(b) Amount

If the entire amount of the toner for electrostatic latent image development is 100% by weight, the amount of the charge control agent is preferably adjusted within a range from 1.5 to 15% by weight. This reason is as follows. When the amount of the charge control agent is less than 1.5% by weight, it becomes difficult to impart charging characteristics to the toner for electrostatic latent image development and thus image density and durability may deteriorate. Also poor dispersion is likely to occur and so-called fog may occur and photoconductor contamination becomes severe. On the other hand, when the amount of the charge control agent is more than 15% by weight, environmental resistance, poor charging under high-temperature and high-humidity and poor image occur and thus problems such as photoconductor contamination may arise. Therefore, the amount of the charge control agent is preferably adjusted within a range from 2.0 to 8.0% by weight, and more preferably from 3.0 to 7.0% by weight, because a balance between the charge controlling function and the durability of the toner for electrostatic latent image development is more improved.

(4) Colorant

As the toner for electrostatic latent image development, various colorants can be added according to the purposes so as to use for black or color application.

a. Black Pigment

magnetite, ferrite powder, carbon black, acetylene black, lamp black, aniline black, etc.

b. Yellow Pigment

chrome yellow, zinc yellow, cadmium yellow, yellow oxide, mineral fast yellow, nickel titanium yellow, naples yellow, naphthol yellow S, hansa yellow G, hansa yellow 10G, benzidine yellow G, benzidine yellow GR, quinoline yellow lake, permanent yellow NCG, tartrazine lake, etc.

c. Orange Pigment

chrome orange, molybdenum orange, permanent orange GTR, pyrazolone orange, vulcan orange, indathrene brilliant orange GK, etc.

d. Red Pigment

blood red, cadmium red, red lead, cadmium mercury sulfide, permanent Red 4R, lithol red, pyrazolone red, watching red calcium salt, lake red D, brilliant carmin 6B, eosine lake, rhodamine lake B, alizarin lake, brilliant carmin 3B, etc.

e. Violet Pigment

manganese violet, fast violet B, methyl violet lake, etc.

f. Blue Pigment

prussian blue, cobalt blue, alkali blue lake, victoria blue lake, phthalocyanine blue, metal-free phthalocyanine blue, phthalocyanine blue partial chlorine compound, fast sky blue, indathrene blue BC, etc.

g. Green Pigment

chromium green, chromium oxide, pigment green B, malachite green lake, final yellow green G, etc.

In case of the toner other than the magnetic toner, the amount of the colorant is preferably from 1 to 20 parts by weight, and more preferably from 2 to 8 parts by weight, based on 100 parts by weight of the fixing resin.

In case of the magnetic toner, the amount is from 50 to 200 parts by weight based on 100 parts by weight of the fixing resin.

(5) Property Modifier

It is preferred that the toner of the present invention for electrostatic latent image development is mixed with colloidal silica or hydrophobic silica as a property modifier for the purpose of improving fluidity and storage stability of the toner for electrostatic latent image development, or subjected to a surface treatment using the colloidal silica. Also the amount of the silica is preferably decided taking account of the amount of the titanium oxide. When the amount of the silica is preferably adjusted within a range from 10 to 150% by weight based on 100% by weight of the amount of the titanium oxide. This reason is as follows. That is, when the amount of the silica is less than 10% by weight, the effect of adding the silica may not be exerted. On the other hand, when the amount of the silica is more than 150% by weight, charging characteristics of the toner for electrophotography may deteriorate. Therefore, the amount of the silica is preferably adjusted within a range from 20 to 140% by weight, and more preferably from 30 to 130% by weight, based on 100% by weight of the amount of the titanium oxide. (6) Average Particle Size

The average particle size of the toner for electrostatic latent image development is preferably adjusted within a range from 5 to 12 μm. This reason is as follows. That is, when the average particle size of the toner for electrostatic latent image development is less than 5 μm, aggregation is likely to occur and storage stability may deteriorate. When the average particle size of the toner for electrostatic latent image development is more than 12 μm, transporting properties may deteriorate or the fixed image may become unclear. Therefore, the average particle size of the toner for electrostatic latent image development is preferably adjusted within a range from 6 to 11 μm. The average particle size of the toner is based on the volume standard and, for example, the average particle size is determined by the following procedure. Using Coulter Counter Multisizer 3 (manufactured by Beckman Coulter, Inc.), Isoton II (manufactured by Beckman Coulter, Inc.) as an electrolytic solution and a 100 μm aperture as an aperture, 10 mg of a measuring sample was added in a solution prepared by adding a small amount of a surfactant in the electrolytic solution and a dispersion treatment was conducted by an ultrasonic distributor to obtain a solution containing the measuring sample dispersed therein. Then, volume distribution of the solution was measured by the measuring apparatus and the average particle size was determined.

2. External Additive

According to the present invention, in order to provide a toner for electrostatic latent image development which exhibits uniform charge amount distribution and exhibits stable charging characteristics without decreasing the triboelectrification amount and causing chargeup, and is also excellent in fluidity, environmental dependence and durability, it is necessary that the titanium oxide as the external additive is treated with a titanate-based coupling agent and then washed with a solvent thereby to adjust the content of the solvent soluble component to 30% or less.

The titanium oxide is classified into anatase and rutile type titanium oxides according to the crystal system, and both titanium oxides can be used in the present invention.

As the titanium oxide to be surface-treated with the titanate-based coupling agent, the followings are used.

(a) Average Particle Size

The average particle size of the titanium oxide is preferably adjusted within a range from 10 to 500 nm. This reason is as follows. That is, when the average particle size of the titanium oxide is more than 500 nm, the photoconductor may be damaged and it may become difficult to mix with toner particles. On the other hand, when the average particle size of the titanium oxide is too small, for example, less than 10 nm, a polishing force to the photoconductor decreased and thus it may become difficult to provide a toner for electrostatic latent image development which is excellent in fluidity, environmental dependence and durability. Therefore, the average particle size of the titanium oxide is preferably adjusted within a range from 10 to 500 nm, and more preferably from 200 to 400 nm. The average particle size of the titanium oxide means its average primary particle size when the titanium oxide is aggregated, and also means a number average primary particle size measured by the following procedure. Specifically, color particles are mixed with fine titanium oxide fine particles as an external additive and then microphotographs were taken by an electron microscope. After digitalization by SemAfore manufactured by JEOL DATUM, Ltd., 100 data were measured by image processing using SemAforeReporter manufactured by JEOL DATUM, Ltd. and the number average primary particle size was determined.

(b) Volume Specific Resistance

When the toner for electrostatic latent image development is used for OPC, the volume specific resistance of titanium oxide is preferably adjusted within a range from 1×10⁴ to 1×10¹⁵ Ω·cm. When used for an a-Si photoconductor, the volume specific resistance of the titanium oxide is preferably adjusted within a range from 1×10¹ to 1×10⁷ Ω·cm. This reason is as follows. That is, if the volume specific resistance of the titanium oxide is not within the above range when the toner for electrostatic latent image development is used for OPC, charging characteristics of the toner for electrostatic latent image development are likely to deteriorate and thus image density decreases to form a void image. If the volume specific resistance of the titanium oxide exceeds 1×10⁷ Ω·cm when used for the a-Si photoconductor, the charge amount excessively increases and thus image density may decrease and durability may deteriorate. Furthermore, when the a-Si photoconductor is used, discharge breakdown may occur because of excess chargeup, and thus a black spot image may be formed. Therefore, when the toner for electrostatic latent image development is used for OPC, the volume specific resistance of the titanium oxide is preferably adjusted within a range from 1×10⁵ to 1×10¹⁴ Ω·cm, and more preferably from 1×10⁶ to 1×10¹³ Ω·cm. When the toner for electrostatic latent image development is used for the a-Si photoconductor, the volume specific resistance of the titanium oxide is preferably adjusted within a range from 1×10² to 1×10⁶ Ω·cm, and more preferably from 1×10³ to 1×10⁵ Ω·cm. The volume specific resistance of the titanium oxide value can be determined while applying a load of 1 kg under the conditions of an applied voltage of DC10 V using ULTRA HIGH RESISTANCE METER (manufactured by ADVANTEST CORPORATION, R8340A).

(c) Surface Treatment

In case of surface treatment of the titanium oxide with a titanate-based coupling agent, as the titanate-based coupling agent, there can be preferably used propyltrimethoxytitanium, propyldimethoxymethyltitanium, propyltriethoxytitanium, butyltrimethoxytitanium, butyldimethoxymethyltitanium, butyltriethoxytitanium, vinyltrimethoxytitanium, vinyldimethoxymethyltitanium, vinyltriethoxytitanium, vinyldiethoxymethyltitanium, hexyltrimethoxytitanium, hexyldimethoxymethyltitanium, hexyltriethoxytitanium, hexyldiethoxymethyltitanium, phenyltrimethoxytitanium, phenyldimethoxymethyltitanium, phenyltriethoxytitanium, phenyldiethoxymethyltitanium, Y-glycidoxypropyltrimethoxytitanium, Y-glycidoxypropyldimethoxymethyltitanium, Y-glycidoxypropyltriethoxytitanium and Y-glycidoxypropyldiethoxymethyltitanium. When the titanium oxide is surface-treated with a titanate-based coupling agent, it is preferred to uniformly mix both components using a mixer or a ball mill. It is also preferred to add an organic solvent such as methanol, ethanol, methyl ethyl ketone or toluene.

The amount of the titanate-based coupling agent to be treated is preferably adjusted within a range from 0.1 to 20 parts by weight, more preferably from 0.5 to 15 parts by weight, and still more preferably from 1 to 10 parts by weight, based on 100 parts by weight of the titanium oxide. When the titanium oxide is surface-treated with the titanate-based coupling agent, it is preferred to be subjected to a heat treatment. For example, the titanate-based coupling agent can be strongly surface-treated by subjecting to a heat treatment at a temperature within a range from 50 to 300° C. for 1 to 60 minutes.

(d) Adjustment of Content of Solvent Soluble Component

It is necessary to adjust the titanium oxide treated with the titanate-based coupling agent obtained by the above method so as to adjust the solvent soluble component to 30% or less. Examples of the method include a method of washing the above titanium oxide subjected to a coupling treatment using an organic solvent as a solvent for eluting a soluble matter, followed by drying, or a method of decreasing the content of the solvent soluble component by adjusting the heating temperature and heating time.

Examples of the organic solvent include n-hexane, n-heptane, n-octane, isooctane, cyclohexane, methylcyclohexane, ethylcyclohexane, toluene and xylene. Among these organic solvents, n-hexane is preferable.

The content of the solvent soluble component is measured as follows. That is, a fixed amount of the titanium oxide is washed by ultrasonic washing in n-hexane. Comparing the C contents before and after washing, the content of the solvent soluble component is determined. Specifically, 2 to 5 g of a measuring sample is weighed and then washed by ultrasonic washing in n-hexane (weight is 10 times as that of the sample) for 5 minutes. Using a carbon content analyzer, the C contents before and after washing are determined and the content of the solvent soluble component is calculated by the following equation (1).
Content of solvent soluble component (%)=[(C content % before washing−C content % after washing)/C content % before washing]×100 (1)

The carbon content can be measured by using a carbon analyzer (EMIA-110, manufactured by HORIBA, Ltd.).

(e) Addition Amount

The amount of the titanium oxide surface-treated with the titanate-based coupling agent is preferably adjusted within a range from 0.1 to 5% by weight based on the toner particles. This reason is as follows. That is, when the amount is less than 0.1% by weight, the polishing effect to the photoconductor may become insufficient or image deletion may occur under high-temperature and high-humidity conditions, and thus image defects occur. On the other hand, when the total amount is more than 5% by weight, since fluidity of the toner for electrostatic latent image development drastically deteriorates, image density and durability may deteriorate. Therefore, the amount of the titanium oxide surface-treated with the titanate-based coupling agent is preferably adjusted within a range from 0.15 to 6.0% by weight, and more preferably from 0.20 to 5.0% by weight.

<Method for Production of Toner>

The toner particles of the present invention can be obtained by a per se known pulverization method. Specifically, toner particles are obtained by passing through a mixing step, a kneading step, a crude pulverization step, a fine pulverization step, a classifying step and an external addition step. Toner particles can be obtained by a chemical method such as known polymerization method, in addition to such a pulverization method.

The volume standard center particle size of toner particles is preferably from 4 to 12 μm, and particularly preferably from 6 to 10 μm.

<Image Forming Method>

The image forming method of the present invention is an image forming method, which comprises the step of developing an electrostatic latent image formed on the surface of a photoconductor using the above toner for electrostatic latent image development. Either of OPC and a-Si photoconductor can be used as the photoconductor. An a-Si photoconductor is preferably used.

Since foreign matters adhered on the surface of the photoconductor and the surface of the photoconductor itself can be polished by using the a-Si photoconductor in combination with the toner of the present invention, it becomes possible to form an image having excellent durability.

### EXAMPLES

The following examples illustrate the manner in which the present invention can be practiced. It is understood, however, that the examples are for the purpose of illustration and the invention is not to be regarded as limited to any of the specific materials or condition therein.

### Example

<Preparation of Titanium Oxide>

Five kinds of titanium oxides were prepared.

(Titanium Oxide 1)

To a rutile type (average primary particle size: 250 nm, volume specific resistance: 1×10⁷ Ω·cm) titanium oxide progenitor, isopropyltriisostearoyltitanate as a titanate-based coupling agent was added in an amount of 5% by weight based on the titanium oxide. After subjecting to a titanate-based coupling agent treatment, the mixture was washed with n-hexanesolvent for 1 minute and dried so as to prepare a solvent soluble matter, and thus a titanium oxide 1 was obtained.

(Titanium Oxide 2)

A titanium oxide 2 was obtained by the same process, except that the time of washing the titanium oxide 1 with an n-hexane solvent was decreased to 30 seconds.

(Titanium Oxide 3)

A titanium oxide 3 was obtained by the same process, except that the time of washing the titanium oxide 1 with an n-hexane solvent was decreased to 10 seconds which is more shorter than that in case of the titanium oxide 2.

(Titanium Oxide 4)

A titanium oxide 4 was obtained by the same process as in case of the titanium oxide 1, except that an anatase type (average primary particle size: 370 nm, volume specific resistance: 1×10⁷ Ω·cm) progenitor was used.

(Titanium Oxide 5)

The titanium oxide 1 in the form of particles, which was not washed with an n-hexane solvent, was taken as a titanium oxide 5.

These titanium oxides are shown in Table 1.

TABLE 1

| | | | | Content of |
|---|---|---|---|---|
| | | Average | | solvent soluble |
| | | particle size | | component |
| | Type | (nm) | Surface treatment | (%) |
| Titanium | Rutile | 250 | Titanate coupling | 8.5 |
| oxide 1 | | | treatment | |
| Titanium | Rutile | 250 | Titanate coupling | 25.0 |
| oxide 2 | | | treatment | |
| Titanium | Rutile | 250 | Titanate coupling | 30.0 |
| oxide 3 | | | treatment | |
| Titanium | Anatase | 370 | Titanate coupling | 14.3 |
| oxide 4 | | | treatment | |
| Titanium | Rutile | 250 | Titanate coupling | 34.5 |
| oxide 5 | | | treatment | |

<Production of Binder Resin>

In a reactor equipped with a thermometer, a stirrer and a nitrogen introducing tube, 300 parts by mass of xylene was charged and a mixed solution containing a mixed monomer of 845 parts by mass of styrene and 155 parts by mass of n-butyl acrylate, and 8.5 parts by mass of di-tert-butyl peroxide (polymerization initiator) and 125 parts by mass of xylene was added dropwise under a nitrogen gas flow at 170° C. for 3 hours. After the dropwise addition, the reaction was conducted at 170° C. for one hour and the polymerization was completed. Then, the solvent was removed to obtain a binder resin.

100 Parts by weight of the styrene-acrylic resin thus obtained was mixed with 100 parts by weight of magnetite (coercive force on application of 796 kA/m: 5.0 kA/m, saturation magnetization: 82 Am²/kg, residual magnetization: 11 Am²/kg, number average particle size: 0.25 μm) as a magnetic powder, 5 parts by mass of carnauba wax and 1 part by mass of a quaternary ammonium salt (manufactured by Orient Chemical Industries, LTD under the trade name of “BONTRON P-51”) using a Henshel mixer, followed by melt-kneading using a twin-screw extruder, cooling using a drum flaker, crude pulverization using a hammer mill, fine pulverization using a turbo mill and further classification using an air classifier to obtain toner particles having a volume average particle size of 7.8 μm.

The toner particles thus obtained were mixed with 1.0% by weight of titanium oxide particles shown in Table 1 and 0.7% by weight of silica (the surface of silica having an average primary particle size of 13 nm is treated with silicone oil and aminosilane) using a Henshel mixer to prepare a magnetic one component positive charge type developer.

Using this developer, initial image characteristics and durability were evaluated by a modified apparatus {28 ppm (A4 size), linear velocity: 175 mm/second} in which a corona charge type page printer FS1920 equipped with a-Si photoconductor manufactured by KYOCERAMITA Corp. is replaced by a contact charging roller type one. As a latent image carrier in a modified apparatus for testing, a thin amorphous silicon having a thickness of 14 μm was used.

The evaluation procedures of the respective characteristics are as follows.

(1) Image Characteristics (Image Density•Fog)

Under a normal-temperature and normal-humidity (20° C., 65% RH), image evaluation patterns were printed by the above page printer and taken as initial images. After continuously copying 100,000 papers and image evaluation patterns were printed again and taken as images after duration. Solid images were measured using a Macbeth reflection densitometer (RD914) and also fog was visually observed, and thus image characteristics were evaluated at initial, or after copying 50,000 papers and 100,000 papers. Image density of 1.30 or more was rated “A”, while image density of less than 1.30 was rated “C”. Fog was evaluated by the following criteria.

A: No fog is observed (fog density is less than 0.01).

B: Fog is slightly observed (fog density is about 0.01).

C: Fog is severely observed (fog density is 0.02 or more).

(2) Drum Contamination

Images were continuously formed and, after confirming that image formation image was completed, a side cover of the above printer (FS1920 modified apparatus) was opened and then a drum unit was taken out. Then, the state of toner adhered on the surface of the drum was evaluated by visually observing the surface of the photoconductor drum. Drum contamination was evaluated by the following criteria.

A: Adhesion of toner is scarcely observed.

B: Adhesion of toner is slightly observed.

C: Adhesion of toner is drastically observed.

The results are shown in Table 2.

TABLE 2

| | | Image density | | | Fog | | | |
|---|---|---|---|---|---|---|---|---|
| | | | After | After | | After | After | |
| | | | copying | copying | | copying | copying | |
| | Titanium | | 50,000 | 100,000 | | 50,000 | 100,000 | |
| | oxide | Initial | papers | papers | Initial | papers | papers | Drum contamination |
| Example 1 | Titanium | A | A | A | A | A | A | A |
| | oxide 1 | | | | | | | |
| Example 2 | Titanium | A | A | A | A | A | A | A |
| | oxide 2 | | | | | | | |
| Example 3 | Titanium | A | A | A | A | A | A | A |
| | oxide 3 | | | | | | | |
| Example 4 | Titanium | A | A | A | A | A | A | A |
| | oxide 4 | | | | | | | |
| Comparative | Titanium | A | A | A | A | B | C | Drum contamination |
| Example 1 | oxide 5 | | | | | | | occurred after copying 20,000 |
| | | | | | | | | papers |

As is apparent from these test results, when using the titanium oxide 5 in which washing with n-hexane is not conducted and the content of the solvent soluble component is 34.5%, image density was sufficiently maintained as compared with the case where the content of the solvent soluble component is within the scope of the present invention, for example, 8.5% (titanium oxide 1), 14.3% (titanium oxide 4), 25.0% (titanium oxide 2) and 30.0% (titanium oxide 3) after washing with the solvent. However, fog began to occur in the visual observation after copying about 20,000 papers and the fog density reached 0.01 after copying about 50,000 papers. After continuous printing, the fog density increased to 0.025 after copying about 100,000 papers. In this test, the surface of the drum was observed after copying about 20,000 papers at which fog could be observed. As a result, adhesion of the toner on the surface of the drum was slightly observed. After the endurance test was conducted by copying 100,000 papers, the surface of the drum was observed. As a result, severe contamination (toner adhesion) occurred. This reason is considered as follows. In case of the comparative example wherein a titanium oxide, the content of the solvent soluble component of which is not within the scope of the present invention is used, the titanium oxide added to the surface of the toner falls off from the surface of the toner by aggregation of titanium oxides and polishing properties of the surface of the photoconductor are lowered, and thus the surface of the photoconductor deteriorates and fog occurred. This fact revealed the meaning of adjusting the content of the solvent soluble component of the titanium oxide to 30% or less.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as limited by the foregoing description but is only limited by the scope of the appended claims.

What is claimed is:

1. A toner for electrostatic latent image development, comprising color particles containing at least a binder resin and a colorant, and an external additive added externally on the surface of the color particles, wherein a titanium oxide is used as the external additive and the titanium oxide is surface-treated with a titanate-based coupling agent, and also the content of a solvent soluble component of the titanate-based coupling agent is 30% or less.

2. The toner for electrostatic latent image development according to claim 1, wherein the titanium oxide has an average particle size of 10 nm or more and less than 500 nm.

3. The toner for electrostatic latent image development according to claim 1, wherein volume specific resistance of the titanium oxide is 1×10⁴ Ω·cm or more and 1×10¹⁵ Ω·cm or less when the photoconductor to be used is an organic photoconductor.

4. The toner for electrostatic latent image development according to claim 1, wherein volume specific resistance of the titanium oxide is 1×10¹ Ω·cm or more and 1×10⁷ Ω·cm or less when the photoconductor to be used is an amorphous silicone photoconductor.

5. The toner for electrostatic latent image development according to claim 1, wherein the content of the solvent soluble component is calculated by the following equation (1):
Content of solvent soluble component (%)=[(C content % before washing−C content % after washing)/C content % before washing]×100 (1)
using the content of C before and after washing with a solvent of the external additive.

6. The toner for electrostatic latent image development according to claim 1, wherein the solvent is n-hexane.

7. The toner for electrostatic latent image development according to claim 1, wherein the titanate-based coupling agent is added in an amount of 0.1 to 20% by weight based on the titanium oxide.

8. The toner for electrostatic latent image development according to claim 1, wherein the titanium oxide is added in an amount of 0.1 to 5% by weight based on the color particles.

9. An image forming method, which comprises the step of developing an electrostatic latent image on the surface of a photoconductor using the toner for electrostatic latent image development according to claim 1.

10. The image forming method according to claim 9, wherein the photoconductor is an amorphous silicone photoconductor.
